(19) United States
(12) Patent Application Publication
(10) Pub. No.: US 2022/0396487 A1
(43) Pub. Date: Dec. 15, 2022

(54) PREPARATION OF EXPANDED GRAPHITE BY PHYSICAL SHEARING

(71) Applicant: CORNELL UIVERSITY, Ithaca, NY (US)

(72) Inventors: Yong Lak JOO, Ithaca, NY (US); Mohammed ALAMER, Ithaca, NY (US)

(21) Appl. No.: 17/621,833

(22) PCT Filed: Jun. 25, 2020
(86) PCT No.: PCT/US2020/039663

§ 371 Date: Dec. 22, 2021

Related U.S. Application Data
(60) Provisional application No. 62/867,813, filed on Jun. 27, 2019.

(51) Int. Cl. C01B 32/225; B01J 19/18; B01J 19/28

(52) U.S. Cl. CPC C01B 32/225; B01J 19/1887; B01J 19/28; C01P 2002/72; C01P 2002/82; B01J 2219/00029

(57) ABSTRACT

Provided herein are high throughput continuous or semi-continuous reactors and processes for manufacturing expanded graphite materials. Such processes are suitable for manufacturing expanded graphite materials with little batch-to-batch variation.

### CROSS-REFERENCE

This application claims the benefit of U.S. Provisional Application No. 62/867,813, filed on Jun. 27, 2019, which application is incorporated herein by reference.

### STATEMENT AS TO FEDERALLY SPONSORED RESEARCH

This invention was made with government support under DMR-1719875 awarded by the NSF MRSEC program. The government has certain rights in the invention.

### BACKGROUND OF THE INVENTION

Expanded graphite is a precursor for the production of expanded, or flexible, graphite, which can be used in a variety of applications including gaskets, thermal insulators, fire-resistant composites, conductive resin compounds, electrodes, liquid sorption applications for heavy oil, dyes, and biomolecules, amongst other applications. The preparation of expanded graphite generally involves introducing an intercalating compound that would penetrate through the graphene sheets that comprise the graphite flake. A number of intercalating agents are used, including halogens, alkali metals, sulfate, nitrate, various organic acids, metal halides, and sulfates. The preparation of expanded graphite is generally done in the industry by the intercalation of sulfuric acid. The mixture could either be exposed to an electric current to complete the intercalation followed by water rinsing or through chemistry oxidation intercalation, followed by blending and heating in a bath at elevated temperatures. Other methods to produce expanded graphite is by exposing natural graphite to ultrasound irradiation and microwave irradiation.

### SUMMARY OF THE INVENTION

Provided in various embodiments herein is expanded and/or expandable graphite. In particular, in some instances, expanded graphite provided herein is further expandable, such as by any suitable process, e.g., shearing techniques described herein and/or chemical techniques. Also provided in certain embodiments herein are processes of manufacturing expanded (and/or expandable) graphite, such as by use of reactors that provide high shear to graphite (e.g., natural or synthetic graphite). In certain embodiments, process provided herein for the manufacture of expanded graphite (e.g., through the use of high shear reactor systems, such as described and provided herein) are suitable for providing highly uniform expanded graphite, e.g., with substantially consistent interlayer spacing between the layers thereof. Moreover, in certain instances, the surface area of exemplary expanded graphite materials can be controlled through provided herein manufacturing process (e.g., shear rate).

In some specific embodiments, provided herein is expanded graphite comprising a plurality of graphene sheets. In more specific embodiments, the plurality of graphene sheets have an average spacing between the graphene sheets (the “interlayer spacing”) of at least 3.35 Å (e.g., 3.35 Å to about 3.45 Å).

In certain embodiments, expanded graphite provided herein has an average interlayer spacing between the graphene sheets is about 3.39 Å to about 3.41 Å (e.g., about 3.4 Å). In certain embodiments, expanded graphite at different shear rates provided herein has an average interlaying spacing about 3.40 Å.

In certain embodiments, expanded graphite provided herein has an X-ray diffraction peak or peaks having a two-theta (2θ) between 25° and 27°, and wherein at least 60% (e.g., at least 70%, at least 80%, at least 85%, at least 90%, at least 95%, at least 98%) of the area under the curve for the X-ray diffraction peak or peaks having a two-theta (2θ) between 25° and 27° is between 26° and 26.5° (26.1° and 26.4°).

In certain embodiments, expanded graphite provided herein has an X-ray diffraction peak or peaks having a two-theta (2θ) between 25° and 27°, and wherein at least 60% (e.g., at least 70%, at least 80%, at least 85%, at least 90%, at least 95%, at least 98%) of the area under the curve for the X-ray diffraction peak or peaks having a two-theta (2θ) between 25° and 27° is within a 0.5° (e.g., 0.4°, 0.3°, 0.25°, 0.2°) range.

In certain embodiments, expanded graphite provided herein has a narrower XRD two-theta (2θ) peak than chemically expanded (e.g., or commercially expanded or expandable) graphite having a peak between a two-theta (2θ) value between 25° and 27°.

In certain embodiments, expanded graphite provided herein has a lower XRD two-theta (2θ) peak value than natural graphite having a two-theta (2θ) peak value (e.g., the graphite having a two-theta (2θ) (e.g., max) peak value of about 26.2-26.4, such as about 26.2-26.3).

In certain embodiments, expanded graphite provided herein has a ratio of the intensity of the Raman Spectroscopy peak positions at the D band peak to the G band peak is 0 to about 0.1 (e.g., about 0.01 to about 0.08, such as about 0.02 to about 0.06 or about 0.04).

Also, provided in certain embodiments herein is a process for manufacturing expanded graphite, the process comprising:
a. introducing a first stock into a reactor, the first stock comprising graphite (e.g., and an additive, such as a surfactant, stabilizing, and/or dispersing agent) and the reactor configured to produce a toroidal non-vortex (e.g., laminar or Couette) flow; and
b. collecting expanded graphite.

In specific embodiments, the reactor is a batch reactor. In other embodiments, the reactor is a semi-batch reactor. In still other embodiments, the reactor is a continuous flow reactor.

In certain embodiments, the reactor and/or the flow is configured to apply shear forces to the first stock (or the components—graphite—therein). In various embodiments, the reactor and/or the flow is configured to apply a shear rate of at least 1,000 s⁻¹ (e.g., at least 5,000 s⁻¹, at least 10,000 s⁻¹) to the first stock (or the components—graphite—therein). In various embodiments, the reactor and/or flow is configured to apply a shear rate of about 32,000 s⁻¹ or less, such as about 30,000 s⁻¹ or less, about 25,000 s⁻¹ or less, or about 20,000 s⁻¹ or less. In some embodiments, the shear rate is about 3,000 s⁻¹ to about 35,000 s⁻¹, such as about 5,000 s⁻¹ to about 25,000 s⁻¹, about 10,000 s⁻¹ to about 20,000 s⁻¹, or about 16,000 s⁻¹. In various embodiments, the fluid stock (or graphite therein) is subject to the reactor for any suitable time. In some instances, short periods of time are preferred and practical for providing high quality expanded graphite, such as provided and described herein. In specific embodiments, a time between introducing the first stock to the reactor and collecting the expanded graphite is less than 6 hours (e.g., about 3 hours or less, about 2 hours or less, about 1-hour or less, or the like).

In specific embodiments, expanded graphite produced according to a process described herein is any expanded graphite described herein.

Generally, the process and/or reactors provided herein are useful for expanding any suitable graphite, such as natural graphite or synthetic graphite. In some embodiments, the graphite of the fluid stock (starting graphite) comprises a plurality of graphene sheets, e.g., such that upon expansion, the distance between the graphene sheets increases (expands). In general, the lateral dimension of the graphene sheets form the lateral dimension of the graphite, and the stacked graphene forms the thickness of the graphite. In some instances, the graphite has an average lateral dimension of about 15 μm or more (e.g., about 15 μm to about 400 μm, about 20 μm or more, about 25 μm or more, or the like). In general instances, the lateral dimension of graphene sheets correlates with surface area of expanded graphite.

In certain embodiments, prior to and/or subsequent to high-shear treatment according to a process described herein, the graphite (e.g., starting or expanded graphite) is further treated with acid and/or other intercalating agents (e.g., so as to partially expand the starting graphite, make the starting graphite more susceptible to expansion, and/or to further expand the mechanically expanded graphite produced according to the high-shear process).

In some embodiments, the graphite is present in the first stock in a concentration of about 5 vol. % to about 25 vol. %. In certain embodiments, the dispersing agent is present in the first stock in a concentration of about 0.05 vol. % to about 5 vol. %. In some embodiments, the stabilizing agent is present in the first stock in a concentration of about 0.05 vol. % to about 5 vol. %. In certain embodiments, the graphite is well dispersed in the first stock (e.g., by stirring for 30-60 minutes before being introduced to the reactor).

In some embodiments, the reactor comprises a reactor chamber into which the first stock is introduced; the reactor chamber being configured between an outer surface of a cylindrical body and the inner surface of a cylindrical bore, one or both of the cylindrical body and/or cylindrical bore rotating around an axis thereof. In certain embodiments, the inner surface of the cylindrical bore rotates while the outer surface of the cylindrical body remains stationary or idle. In some embodiments, the outer bore surface rotates. In some embodiments, the outer surface of the cylindrical body rotates while the inner surface of the cylindrical bore remains stationary or idle. In some embodiments, the inner surface of the cylindrical body rotates in the opposite direction. In certain embodiments, the cylindrical body forms an elliptical (or oval), or circular cylinder. In some embodiments, the cylindrical bore is a circular cylindrical bore. In certain embodiments, the reactor is a (e.g., batch or continuous) Taylor-Couette reactor (TCR).

In certain embodiments, a fluid stock provided herein (e.g., a (non-expanded) graphite comprising stock for use in a process described herein) is aqueous. In some embodiments, the expanded graphite is also collected in an aqueous stock, e.g., which can then be used in further processing (e.g., without needing extensive pre-treatment). In typical processes in the art, graphite is chemically expanded using rigorous conditions, such as acids (e.g., as described herein). In certain instances, before such chemically expanded graphite can be further utilized, it must be further processed, such as by removing and capturing acid, etc. Use of aqueous stocks provided herein eliminate the need for such extensive and expensive processing to obtain expanded graphite in a processable form.

In certain instances, expandable graphite is a crucial precursor for the production of expanded, or flexible, graphite, which can be used in a variety of applications including gaskets, thermal insulators, fire-resistant composites, conductive resin compounds, electrodes, liquid sorption applications for heavy oil, dyes, and biomolecules, amongst other applications. The preparation of expandable graphite includes introducing an intercalating compound that would penetrate through the graphene sheets that comprise the graphite flake. A number of intercalating agents are used, including halogens, alkali metals, sulfate, nitrate, various organic acids, metal halides, and sulfates. The preparation of expandable graphite is generally done in the industry by the intercalation of sulfuric acid. The mixture could either be exposed to an electric current to complete the intercalation followed by water rinsing or through chemistry oxidation intercalation, followed by blending and heating in a bath at elevated temperatures. Other methods to produce expandable graphite is by exposing natural graphite to ultrasound irradiation and microwave irradiation.

In some instances, our invention utilizes a TCR system where the outer cylinder is rotating while the inner cylinder is still while suspending natural graphite, e.g., in an aqueous solution with the addition of surfactant agents. This results in applying high shear force without the forming of centrifugal-driven flow structures, resulting in an aligned shear force that results in the formation of expanded and/or expandable graphite.

In some instances, graphite is pre-dispersed in aqueous solutions with the aid of a dispersion system that consists of a dispersing agent, e.g., a polymer, block-co-polymer, or an organic compound, and/or a stabilizing agent. In specific embodiments, graphite used is natural or synthetic graphite with size varying between 15-400 μm. In some instances, graphite is pre-treated/washed with acid or other intercalating agents to expand the graphite flakes. In certain instances, graphite volume percentage in the aqueous solution varies between 10-20 vol. %. In some instances, dispersant agent percentage varies between 0.1-3 vol. %. In certain instances, stabilizing agent percentage varies between 0.05-3 vol. %. In some instances, the solution is stirred any suitable amount of time, such as for about 30-60 minutes to ensure homogeneity of the solution.

In specific instances, processes provided herein utilize a (e.g., Taylor-Couette) reactor system, such as operating in batch or in continuous manner. In certain instances, the reactor comprises a rotating outer cylinder and a stationary inner cylinder. In specific instances, the gap width between the inner and outer cylinders is any suitable distance, such as about 0.00762 to about 1.27 cm (about 0.003 to about 0.5 inches). In more specific instances, the gap width between the inner and outer cylinder is about 0.0127 to about 0.127 cm (about 0.005 to about 0.05 inches). In some instances, the shear rate can be varied by varying the gap width between the inner cylinder and outer cylinder (bore), even when the rotation speed of the rotating cylinder (outer cylinder) is the same. In certain specific instances, the reactor length is any suitable length, such as about 5-24 inches. In some instances, any suitable rotation speed of the outer cylinder is utilized, such as about 1200-15000 RPM. In certain instances, stock is pre-heated prior to expansion inside the reactor. In certain other embodiments, such reactor systems are appropriately scaled, such as to provide proportional size ratios and/or performance (e.g., shear) effects. In some instances, batch processing proceeds for about 30 minutes to about 12 hours. In certain instances, continuous (or semi-continuous) processing is more rapid, such as taking about 1 minute to about 1-hour. In some embodiments, the stock is subject to room temperature or at elevated temperatures.

Any suitable post-processing steps are also contemplated herein. For example, in some instances, after expansion, the resultant composition is collected. In certain embodiments, expanded graphite is separated from non-expanded graphite. In some instances, the composition allowed to settle, such as allowed to rest for about 4-48 hours. In some instances, such a process allows for the settling of larger unexpanded or under-expanded graphite particles. In certain embodiments, separation of expanded graphite from non-expanded graphite is achieved through other processes, such as centrifugation. In specific instances, centrifugation occurs for about 90-120 minutes at speeds of about 500-3300 RPM. In certain instances, a separation step provided herein produces (e.g., clear) phase separation with dispersed expanded graphite particles suspended and solid particles (e.g., comprising unexpanded or under-expanded) graphite settling at the bottom.

In certain embodiments, the shear rate of the batch processing is varied by changing the gap width and resultant exemplary expanded graphite material is collected. In specific instances, the shear rate is about 1,000 s⁻¹ to about 32,000 s⁻¹ and the resulting graphite material surface area and % light transmittance is controlled.

In some instances, the expanded graphite suspension or solution is then removed (e.g., pipetted out) and collected for further use, such as an (e.g., unaltered) suspension in an aqueous medium. In certain embodiments, direct manufacture of the expanded graphite (particularly in an aqueous medium) allows for ready use in downstream processing technologies. In other words, while in some instances the expanded graphite is condensed and/or dried, it is not necessary to do so. In many industrial applications, it is necessary to suspend graphite into aqueous compositions for processes, which can be extremely difficult.

For example, in certain exemplary embodiments, an expanded graphite provided (e.g., as a suspension provided herein) is spun (e.g., wet-spun, such as according to a process described herein) into carbon (e.g., expandable or expanded graphite) fibers (e.g., and thermally treated to strengthen the fiber, such as by connecting bonds between graphene sheets of the expanded graphite of the fiber). As demonstrated herein, expanded graphite produced by such shearing processes produce carbon fibers with significantly improved performance characteristics compared to those similarly prepared using conventional (chemically) expanded/expandable graphite. This demonstrates the improved applicability and usefulness of such expanded graphite. In certain other applications contemplated in certain embodiments herein, a suspension provided herein is alternatively drop casted, vacuum filtered, freeze-dried, and/or separated in other processes.

In certain instances, a value “about” an indicated value is a value suitable for achieving a suitable result and/or a result similar as achieved using the identified value. In some instances, a value “about” an indicated value is between ½ and 2 times the indicated value. In certain instances, a value “about” an indicated value is ±50% the indicated value, ±25% the indicated value, ±20% the indicated value, ±10% the indicated value, ±5% the indicated value, ±3% the indicated value, or the like.

These and other objects, features, and characteristics of the batteries, electrodes, materials, compositions and/or processes disclosed herein, will become more apparent upon consideration of the following description and the appended claims with reference to the accompanying drawings and examples, all of which form a part of this specification. It is to be expressly understood, however, that the drawings and examples are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a schematic of an exemplary toroidal flow reactor provided herein.

FIG. 2 illustrates a schematic of an exemplary toroidal flow reactor provided herein, with a variety of inlets and an outlet.

FIG. 3 illustrates the cross section of a reactor comprising a rotating elliptical cylindrical inner body (or surface thereof).

FIG. 4 illustrates the cross section of a reactor comprising a circular cylindrical inner body and a rotating circular cylindrical outer body (or surface thereof).

FIG. 5 illustrates X-ray diffraction (XRD) traces of natural graphite, commercial expandable graphite, and exemplary expanded graphite materials utilized in processes and compositions herein.

FIG. 6 illustrates interlayer spacing of natural graphite and exemplary expanded graphite materials utilized in processes and compositions herein.

FIG. 7 illustrates Raman spectra of natural graphite, commercial expandable graphite, and exemplary expanded graphite materials utilized in processes and compositions herein.

FIG. 8 illustrates scanning electron microscope (SEM) imagery of commercial expandable graphite and exemplary expanded graphite materials utilized in processes and compositions herein.

FIG. 9 illustrates various exemplary flow types of a process or reactor provided herein

FIG. 10 illustrates tensile strengths of commercial carbon fibers.

FIG. 11 illustrates tensile strengths of exemplary carbon fibers utilized in processes and compositions herein.

FIG. 12 illustrates scanning electron microscope (SEM) imagery of commercial carbon fibers and exemplary carbon fibers utilized in processes and compositions herein.

FIG. 13 illustrates a schematic of an exemplary semi-continuous toroidal flow reactor provided herein, with an inlet (additional inlets are optional) and an outlet.

FIG. 14 illustrates a schematic of an exemplary continuous toroidal flow reactor provided herein, with an inlet (additional inlets are optional) and an outlet.

FIG. 15 illustrates an exemplary system provided herein comprising a plurality of exemplary reactors provided herein.

FIG. 16 illustrates the surface area of exemplary expanded graphite materials at different shear rates utilized in exemplary processes and compositions herein.

FIG. 17 illustrates the interlayer spacing of exemplary expanded graphite materials at different shear rates resulting from different gap width utilized in exemplary processes and compositions herein.

FIG. 18 illustrates the interlayer spacing of exemplary expanded graphite materials at different rotation speeds with a narrow gap utilized in processes and compositions herein.

FIG. 19 illustrates the transmittance percentages of exemplary expanded graphite materials at different shear rates utilized in exemplary processes and compositions herein.

FIG. 20 illustrates a cross sectional schematic of an exemplary toroidal flow reactor with different inner cylinder diameter and gap provided herein.

### DETAILED DESCRIPTION OF THE INVENTION

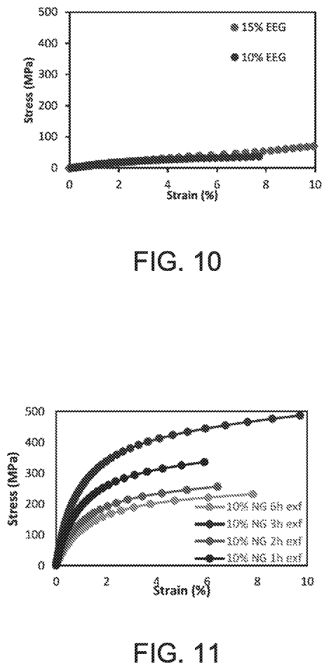

Provided in certain embodiments herein are processes and systems for manufacturing graphite components, such as expanded graphite, including expanded graphite with multiple layers of graphene sheets. Also provided herein are compositions used to make carbon fiber products described herein and/or the carbon fiber products produced or produce-able by processes or from compositions described herein. In specific instances, the processes provided herein are continuous or semi-continuous (flow) processes. In certain instances, processes provided herein facilitate greatly improved (reduced) manufacturing times for expanded graphite products. Moreover, in some instances, processes provided herein facilitate greater control of the interaction between reagents of the processes thereof, providing greater control of and greater quality control of resulting expanded graphite products. For example, in certain embodiments, provided herein are processes that are utilized to control the interlayer spacing between graphene layers, the number of layers, the lateral dimension, other characteristics, or combinations thereof of expanded graphite products produced thereby. In addition, with the ability to precisely control flow, rotation/vortex parameters, and inputs characteristics, timing and location, greater quality control of the resultant products is achieved, whether the expanded graphite product is first out, last out, somewhere in-between, or even during a different run or using a separate system. Moreover, expanded graphite products provided herein are suitable, in some embodiments, for the manufacture of high performance carbon fibers, such as comprising high graphenic content, particularly along the longitudinal axis of the fibers. Surprisingly, fiber formation from the expanded graphite provided herein provides such graphenic structures in carbon fibers provided herein, despite the use of partially exfoliated graphene sheets (e.g., present in the expanded graphite) rather than fully exfoliated graphene sheets. In addition, use of expanded graphite from the mechanical expanded graphite provided herein provides significantly better results than commercial expanded/expandable graphite prepared using chemical processes as described herein. As shown in FIG. 10, carbon fibers produced from commercial expanded/expandable graphite have a tensile strength below 100 MPa. More specifically, the tensile strength is between about 30 to about 80 MPa. As shown in FIG. 11, carbon fibers manufactured from expanded graphite materials made from chemical processes as disclosed herein have tensile strengths ranging from about 200 MPa to about 500 MPa. As such, the chemical processes described herein and expanded graphite components formed therefrom allow for much stronger carbon fiber formation than carbon fibers formed from commercial expanded/expandable graphite. The ability to precisely control the chemical processes described herein to produce highly uniform expanded graphite materials allow for such high strength carbon fiber production on a uniform basis with very little bath to batch variation.

In specific embodiments, provided herein is a process for manufacturing an expanded graphite compound, the process comprising:
a. injecting a first stock into a first inlet of a continuous or semi-continuous reactor, the first stock comprising graphite;
b. and collecting the expanded graphite compound from an outlet of the continuous reactor, the expanded graphite compound being collected downstream from the injection points of the first stock.

In specific embodiments, the reactor having a fluid flowing therein, the flow having a flow type as described herein (e.g., laminar flow, toroid flow, or the like). In some instances, the fluid within the reactor comprises the first (graphite) stock, such as alone or in combination with one or more other fluid provided to the reactor.

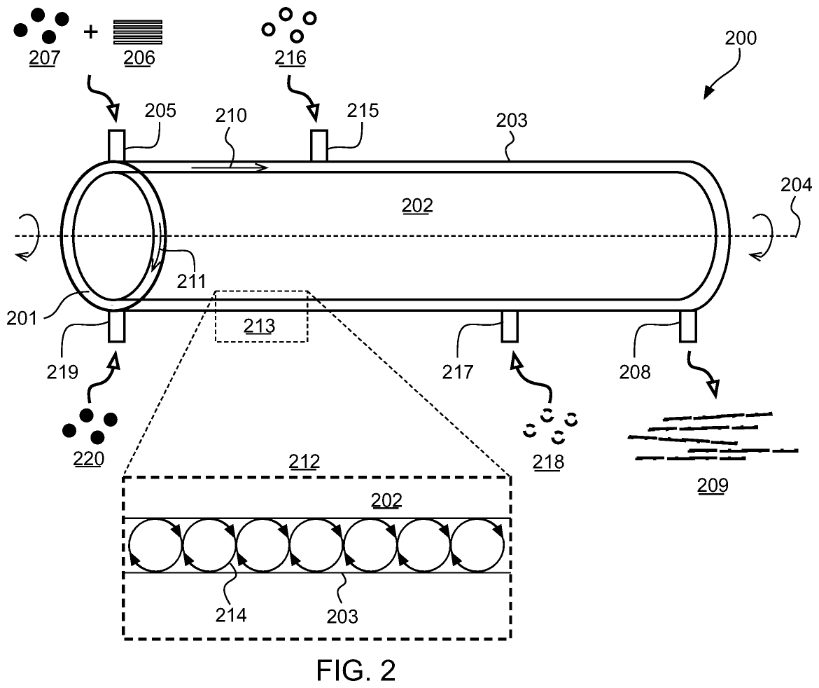

FIG. 2 illustrates an exemplary embodiment of a process and a reactor 200 provided herein. As illustrated, the reactor 200 comprises a reaction chamber 201 into which the stock(s) are injected, the reactor chamber 201 being configured between an outer wall of a first body 202 and an inner wall of a second body 203. In specific embodiments, the outer wall of the first body 202 defines a cylindrical body and the inner wall of the second body 203 defines a cylindrical bore. In some instances, the first body 202 and/or the second body 203 is configured to rotate about or around an axis 204 thereof. In certain embodiments, the wall(s) of the cylindrical body and/or bore rotate(s) around an axis of the respective cylinder body and/or bore. In certain embodiments, the cylindrical bore rotates. In certain embodiments, the wall(s) of the cylindrical body and/or bore rotate(s) in an opposite direction. The cylindrical body and/or bore form any suitable shape, such as a circular cylinder, an elliptical cylinder, a right cylinder, an oblique cylinder, or the like. In certain embodiments, the cylindrical bore and/or body is optionally substituted with conical frustum bore and/or body, respectively. In various embodiments, the first body and the second body (e.g., inner and outer walls or surfaces thereof, respectively) comprise any suitable material.

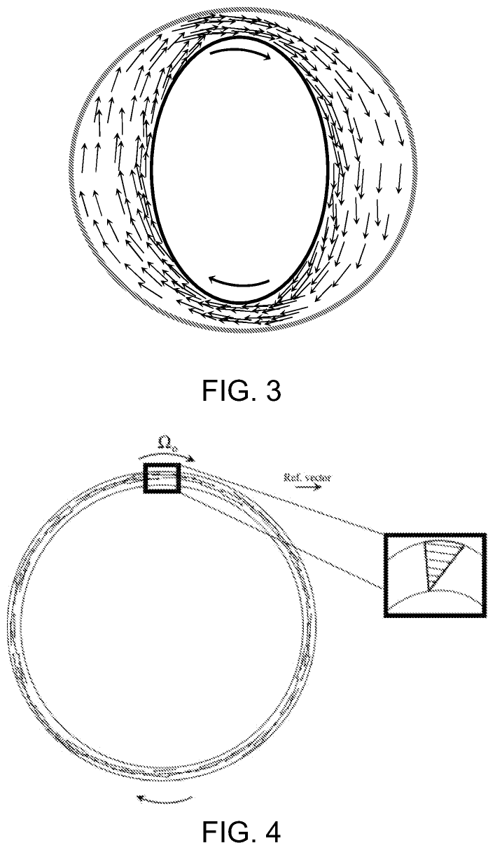

FIG. 3 illustrates the cross section of a reactor comprising a reaction chamber configured between the inner wall of a circular cylindrical outer (second body) and the outer wall of an elliptical cylindrical inner (first) body. As illustrated in FIG. 3, in some preferred embodiments, the inner cylindrical body of such a reactor rotates. In some instances, use of an elliptical inner body facilitates good (non-vortex) toroidal shear flow within the reactor, even at higher rotation speeds. By contrast, in some instances, use of a circular cylindrical inner body results in a non-vortex, toroidal shear flow only at low rotation speeds, with the shear flow quickly destabilizing to form a toroidal vortex flow. FIG. 4 illustrates the cross section of a reactor comprising a reaction chamber configured between the inner wall of a circular cylindrical outer (second) body and the outer wall of a cylindrical inner (first) body. As illustrated in FIG. 4, in some preferred embodiments, the outer cylindrical body of such a reactor rotates. In some instances, rotation of the outer body facilitates good (non-vortex) toroidal shear flow within the reactor chamber, even at higher rotation speeds. In some instances, rotation of the inner body leads to vortex (rather than shear) flow even at low speeds or revolutions per minute (rpm), whereas rotation of the outer body allows much higher speeds and shear rates to be achieved. In certain instances, increasing shear increases expansion or interlayer spacing between graphene layers of graphite provided herein. In some instances, high shear processes provided herein facilitate the production of graphites or graphitic particles having large interlayer spacing, while also maintaining large lateral dimensions and/or surface area. The rotation of the second body 203 is quantified in dimensional form of the second body's 203 angular velocity Ωₒ, and in dimensionless form by the Reynolds number Reₒ, as seen in Equation 1, using the kinematic viscosity of the Newtonian fluid between the first body 202 and second body 203.

$${Re}_{o} = \frac{{r}_{o} {Ω}_{o} d}{v} \qquad ( Equation 1 )$$

By contrast, in some instances, rotation of the circular cylindrical inner body results in a non-vortex, toroidal shear flow only at low rotation speeds, with the shear flow quickly destabilizing to form a toroidal vortex flow.

In some embodiments, the first body and the second body (e.g., inner and outer wall or surfaces thereof, respectively) independently is or comprises a stainless-steel alloy (e.g., 304 stainless steel, 310M stainless steel), an austenitic stainless steel (e.g., Avesta 254 SMO), an austenitic chromium-nickel stainless steel (e.g., 316 stainless steel), a super duplex stainless steel alloy (e.g., ZERON® 100), polytetrafluoroethylene (e.g., TEFLON™), glass (e.g., borosilicate) coated metal, borosilicate glass, polytetrafluoroethylene (e.g., TEFLON™) coated metal, nickel-chromium-molybdenum-tungsten alloy (e.g., Alloy 22), stainless steel with silicon, a Ni—Fe—Cr—Mo alloy (e.g., Alloy 20, Alloy G-30, Alloy 33, Cronder 2803 Mo), a Ni—Cr—Mo alloy (e.g., Alloy C-22, Alloy-C-276, Hastelloy C-2000), an alloy (e.g., LEWMET, Hastelloy D-205,Sandvik HT 9076), lead, high silicon cast iron, cast iron (e.g., Meehanite, grey cast iron), ductile iron (e.g., MONDI), any combination thereof, or the like.

As illustrated in FIG. 2, exemplary embodiments of the reactor have at least one inlet 205 configured to receive a stock, particularly a graphite stock (e.g., a stock comprising graphite 206, such as in a suspension). In some instances, the graphite stock further comprises a surfactant, stabilizing, dispersing, and/or thickening agent 207. In some instances, the graphite stock may be an aqueous solution with the graphite suspended therein. The reactor further comprises at least one outlet 208, from which product is extracted from the reactor. In the case of a continuous flow reactor, the extracted product comprises the expanded graphite component 209. In the case of a semi-continuous or semi-batch reactor, the extracted product is injected back into the reactor one or more times until expanded graphite component is ultimately collected from the reactor. In general, the reactor facilitates the (axial) flow 210 of the stock(s) and/or reagents from one or more inlet 205 of the reactor to one or more outlet 208 of the reactor 200. Moreover, with one or more of the inner cylinder or the inner surface of the bore cylinder rotating relative to the other, the flow has a toroidal and/or lateral aspect 211. Moreover, as illustrated in the expanded view 212 of the cut-out 213, the flow of the fluid within the reactor comprises, in some instances, a plurality of vortices (a vortex flow herein) 214. In some preferred embodiments, the rotation speed of the first and/or second bodies are maintained at a rate (e.g., that is slow enough) to prevent the destabilization of a non-vortex or shear flow, such as forming the vortices 214 in the expanded view of 213. In some instances, a batch reactor configured such as described herein can be configured to provide a plurality of stirred domains (e.g., the series of domains or vortices can be considered a series of continuous stirred tank reactors) or vortices such as illustrated in the expanded view of 212, wherein each of the plurality of vortices have a toroidal shape, such as illustrated in FIG. 3. In certain instances, with the flow 210 of a continuous or semi-continuous reactor 200 herein, the toroidal shapes of the vortices 214 are distorted (e.g., forming distorted toroidal vortices), such as forming vortices with a helical shape (e.g., forming helical vortices).

As illustrated in FIG. 2, additional inlets are optionally included in a reactor provided herein. In certain instances, a continuous or semi-continuous reactor provided herein comprises at least one additional inlet for injecting one or more reagent into the reactor. As illustrated in the reactor 200, in certain embodiments, the reactor 200 comprises, in some embodiments, a second inlet 215 facilitating the injection of a desired agent 216 into the reactor chamber 201. As exemplarily illustrated, the second inlet 215 is downstream from the first inlet 205. In some instances, a reactor 200 provided herein comprises a (optional) third inlet 217, such as for injecting a desired agent 218 into the reactor chamber 201. Additional inlets can also be provided, as desired. For example, the reactor 200 of FIG. 2 illustrates an additional inlet 219 that is near the first inlet 205, the additional inlet 219 being configured for injecting any suitable or desired agent 220 into the reactor chamber 201.

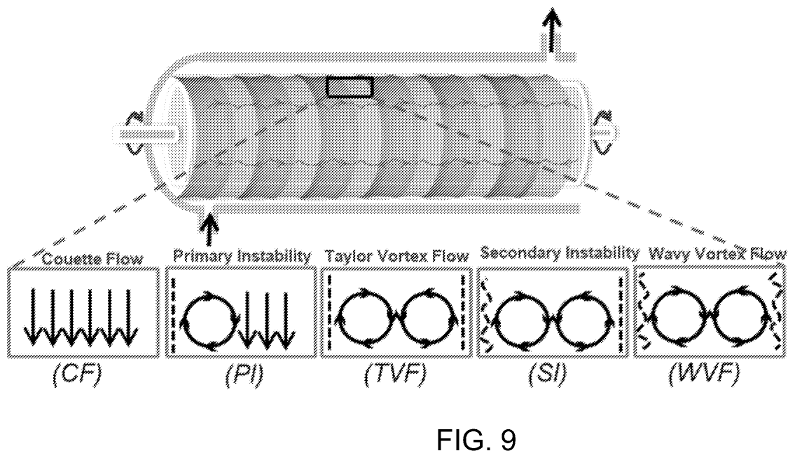

In certain embodiments, a reactor provided herein has a (e.g., fluid) flow (e.g., within the chamber thereof) from an input to an output (e.g., at different axial positions of the reactor). In other words, one or more fluid stock (e.g., solutions, suspensions, or combinations thereof) is input into the reactor via one or more inlet, such one or more fluid stocks shearing, mixing and flowing toward and out of one or more outlet, at least one outlet being down-flow (“downstream”) from the one or more inlet. In various embodiments, any suitable flow is provided within the reactor (e.g., chamber thereof), such as a toroidal flow, a vortex flow (e.g., a Taylor vortex flow), a non-vortex flow, a shearing flow, a laminar flow (e.g., a Couette flow), a turbulent flow, and/or the like. In some embodiments, the fluid has a toroidal flow. In certain embodiments, the fluid has a non-vortex flow, such as a toroidal non-vortex flow. In some embodiments, a reactor provided herein is configured to provide a non-vortex flow, e.g., non-toroidal vortex flow, within a reactor chamber thereof. In certain embodiments, the flow is a modified Couette flow (e.g., a (non-vortex) Taylor-Couette with axial flow) and/or the reactor is a continuous Taylor-Couette reactor. In specific embodiments, the flow dynamics are configured by adjustment of flow rate, drum size, bore size, gap between the inner wall and the outer wall, rotation speed, or any combination thereof. FIG. 9 illustrates a Taylor vortex flow, however, depending on the rotation speed, rotating body, rotation direction, etc., other flow types can be observed in the reactor.

FIG. 9 illustrates the Couette (laminar) flow observed at slow (inner) rotational speeds (e.g., wherein Ta<Ta_{c}). Further, as illustrated in FIG. 9, when Ta exceeds Ta_{c}, vortexes form, but when Ta is close to Ta_{c}, instabilities (vortexes) form near the reactor inlet, but as the flow continues toward the reactor exit, laminar flow resumes. This type of flow is illustrated as primary instabilities (PI). As Ta increases, instabilities form throughout the reactor, forming a Taylor vortex flow (TVF). Increasing the Ta/Ta_{c} further, however, creates a secondary instability (SI), where a wavy flow is observed near the inlet of the reactor. Further increase of Ta/Ta_{c} leads to a full wavy vortex flow (WVF). In some embodiments, the flow is a stable laminar (e.g., Couette) flow and/or a flow having a Ta/Ta_{c} of less than 1, such as less than 0.9, such as less than 0.8 (e.g., 0.5 to 0.9 or 0.6 to 0.8). In certain embodiments, the flow is a stable vortex (e.g., Taylor) flow and/or a flow having a Ta/Ta_{c} of about 1.05 to about 1.4, such as about 1.05 to about 1.3, such as about 1.1 to about 1.2.

In certain embodiments, a process or reactor provides a high shear (e.g., to graphite, such as injected or utilized therein). Shear rate is determined by any suitable process, such as y=v/h, wherein y is shear rate measured in reciprocal seconds, v is velocity of a moving plate (e.g., relative to a stationary plate, such as described herein), and h is the distance between parallel plates. In some instances variations are contemplated to account for the cylindrical shapes contemplated herein. In some embodiments, high shear rates are provided by the flows described herein, such as at least 10³ s⁻¹, at least 5×10³ s⁻¹, at least 10⁴ s⁻¹ or the like. In some embodiments, high shear rate is about 4×10⁴ s⁻¹ or less, about 3.2×10⁴ s⁻¹ or less, about 3×10⁴ s⁻¹ or less, about 2.5×10⁴ s⁻¹ or less, about 2×10⁴ s⁻¹ or less, or the like. In certain embodiments, high shear rate is about 0.5×10⁴ s⁴ to about 3.5×10 s⁻¹, about 1×10⁴ s⁻¹ to about 3×10⁴ s⁻, about 1.5×10⁴ s⁻¹ to about 2×10⁴ s⁻, or the like. In some instances, a small gap corresponds with high shear. In certain instances, at larger diameters, higher cylinder/bore surface velocities are achieved at lower rotation rates. In certain embodiments, a reactor provided herein has a gap between the inner surface of the outer body and the outer surface of the inner body (“gap”) that is relative to the radius of the inner surface of the bore (“rₒ”). In some embodiments, gap/r₀ is about 0.001 to about 0.2, such as about 0.01 to about 0.2 about 0.03 to about 0.1, about 0.002 to about 0.05, about 0.005 to about 0.05, about 0.01 to about 0.03, or the like. In some embodiments, the gap is any suitable distance, such as 0.00762 to about 1.27 cm (0.003 to about 0.5 inches) and preferably about 0.0127 to about 0.127 cm (0.005 to about 0.05 inches). In some instances, larger gaps are utilized (e.g., when the bores are larger, such as in a ratio provided herein).

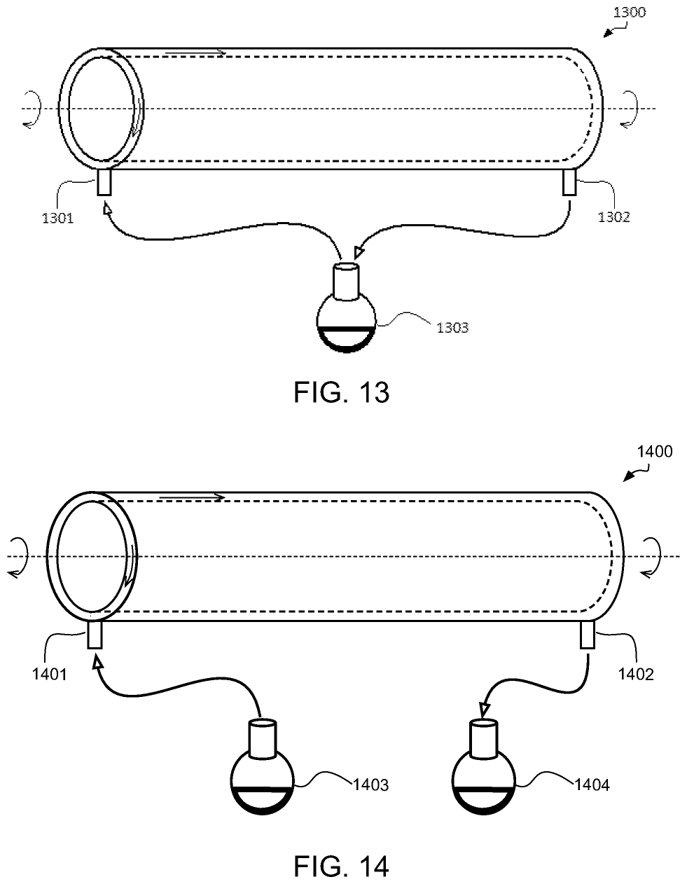

In various embodiments, a process provided herein utilizes or a system herein comprises any suitable reactor, such as a toroidal reactor. In some embodiments, the toroidal reactor is a toroidal flow reactor, a toroidal batch reactor, or the like. In various embodiments, the toroidal flow reactor is a toroidal continuous flow reactor, or a toroidal semi-continuous (semi-batch) reactor. FIG. 13 illustrates an exemplary toroidal semi-continuous (semi-batch) reactor provided herein. As illustrated, the reactor 1300 has at least one inlet 1301 and at least one outlet. In some instances, the reactor is charged via an opening or via the inlet 1301, such as with graphite and other reaction or suspending agents (e.g., surfactant, stabilizing, dispersing and/or thickening agents), such as described herein. After being subjected to the reactor, a reaction mixture (e.g., a stock) is expelled from the outlet 1302 and recycled back into the inlet 1301 (or a different inlet (not shown)). The outlet 1302 optionally feeds directly back into the inlet 1301, or proceeds through a collection container 1303. After a desired time or number of passes through the reactor 1300, the (e.g., final) expanded graphite product is expelled via an outlet 1302 and collected, such as in a collection receptacle 1303. The reactants are optionally subjected to the reactor any suitable number of times (passes through the reactor), such as one or more times, two or more times, 5 or more times, 10 or more times, or the like. FIG. 14 illustrates an exemplary toroidal continuous flow reactor, wherein a stock 1403 is provided to an inlet 1401 of a reactor provided herein, and the reaction product 1404 is collected via an outlet 1402 of the reactor 1400 after a single pass through the reactor.

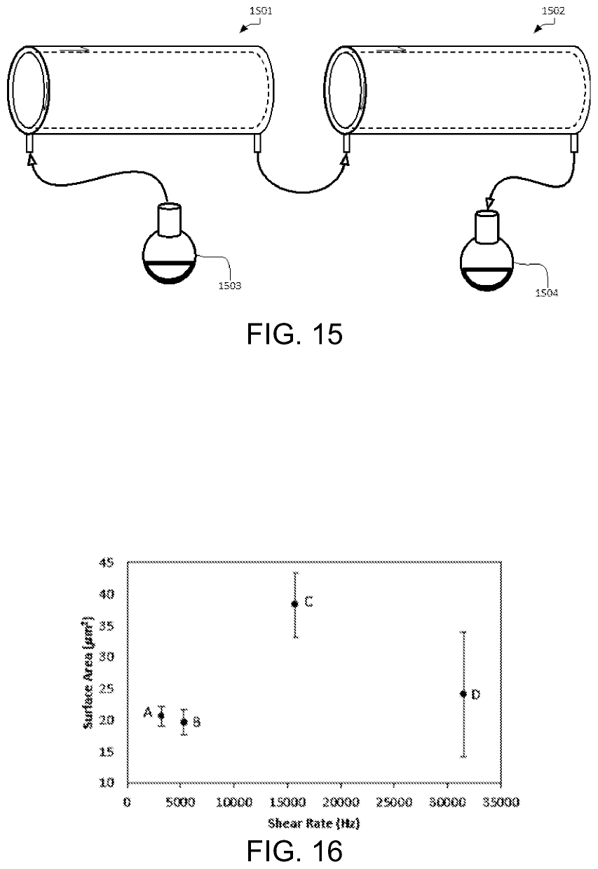

In some embodiments, a system herein comprises (or a process provided herein comprises using) a series of reactors, such as illustrated in FIG. 15. FIG. 15 illustrates an exemplary system comprising a plurality of reactors (e.g., a first reactor 1501 and a second reactor 1502) provided herein, such as wherein a stock is provided to an inlet of a first reactor 1501, a first product is provided via an outlet of the first reactor 1501, the first product is provided to an inlet of a second reactor 1502 and a second product is provided via an outlet of a second reactor 1502. In some instances, the first product is optionally treated prior to providing to the second reactor. For example, in some instances, expanded graphite product is separated or extracted from the first product before subjecting the remainder of the first product to the second reactor. FIG. 15 illustrates an exemplary continuous flow reactor, but semi-batch or semi-continuous reactors of such configurations are also provided herein.

In certain embodiments, the reactor comprises one or more temperature controlled domains. In certain embodiments, a jacket or coil is positioned in at least partial surrounding relation to the outer wall of the reactor. In some instances, the temperature control domain is a cooling domain (e.g., wherein the jacket or coil comprises a coolant). In certain embodiments, a system provided herein has a first temperature controlled domain comprising a cooling domain and a second temperature controlled domain comprising a heating domain. In some instances, a first and a second reactor are provided in a system herein, such as illustrated in FIG. 15, wherein the first reactor is cooled and the second reactor is heated.

In certain embodiments, graphite utilized herein is any suitable graphite, such as natural graphite, natural graphite flake, synthetic graphite, any combination thereof, or the like. In certain embodiments, the graphite is a multi-layered structure comprising any suitable number of layers and/or having any suitable (e.g., particle) dimension or size. In certain instances, a graphite provided herein comprises at least 25 layers (e.g., graphitic carbon layers stacked on top of one another), at least 50 layers, at least 75 layers, or the like. Various graphitic particle sizes are optionally utilized, such as having an average size of at least 1 micron, at least 5 micron, at least 10 micron, at least 25 micron, at least 100 micron, at least 200 micron, and least 300 micron, at least 400 micron, or the like. In specific instances, the average particle size is less than 1 mm, less than 500 micron, less than 250 micron, less than 100 micron, or the like. Any suitable concentration of graphite is utilized in a stock and/or reactor herein. In specific embodiments, the concentration of graphite in a stock described herein is about 0.1 wt. % to about 50 wt. %, e.g., 0.5 wt. % to 50 wt. %. In specific embodiments, the concentration of graphite in a stock described herein is about 5 vol. % to about 25 vol. %, e.g., 10 vol. % to 25 vol. %.

In some embodiments, any suitable strong acid, oxidizing agent and/or intercalating agent provided is utilized herein. In some embodiments, the strong acid, oxidizing agent and/or intercalating agent functions to swell and/or intercalate into and/or oxidize the graphite layers. In some embodiments, the strong acid, oxidizing agent and/or intercalating agent comprises one or more of the following: sulfuric acid, bisulfate, sulfate, nitric acid, nitrate, perchloric acid, perchlorate, permanganate, phosphoric acid, phosphate, biphosphate, or the like. In the case of bisulfate, sulfate, nitrate, perchlorate, permanganate, phosphate, biphosphate, or other anion utilized, any suitable cation is optionally utilized, such as sodium, potassium, or the like. It is to be understood that in a stock, however, reference to an ion or salt herein includes reference to the compound in ionic (e.g., solvated or disassociated) or salt form. Concentrations of strong acids or intercalating agents utilized herein are present in any suitable amount.

In certain embodiments, a process herein includes subjecting a reaction mixture (e.g., a stock) to a dispersant agent or a stabilizing agent. Any suitable dispersant or stabilizing agent is utilized in any method or system or composition described herein. In specific embodiments, the dispersant agent is present in a reaction mixture (e.g., a stock) in a concentration of about 0.05-5 vol. %. In specific embodiments, the stabilizing agent is present in a reaction mixture (e.g., a stock) in a concentration of about 0.05-5 vol. %.

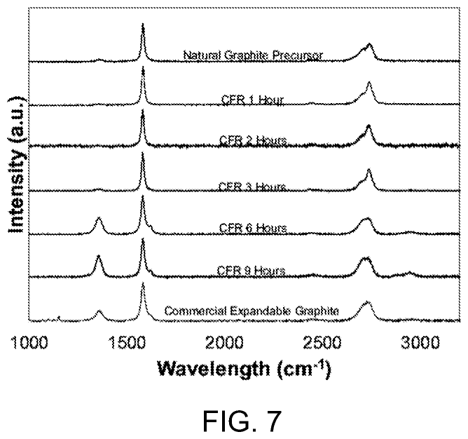

In various instances herein, reactors (batch and flow) produce very consistent expanded graphite materials batch-to-batch (including, in the case of flow reactors, on a run-to-run basis or a first out, last out basis). As illustrated in the Raman spectra of FIG. 7, processes and reactors provided herein are suitable for producing highly consistent materials on a batch-to-batch basis, as indicated by the low ratio of the intensity of the D band peak (about 1350 cm-1) to the intensity of the G band peak (about 1587 cm-1). Moreover, by controlling, where, when and what reagents are added to the reaction, with a high degree of precision, reactors provided herein prove a highly tunable platform to produce expanded graphite materials.

FIG. 7 further illustrates the uniformity of the expanded graphite compounds produced according to the processes herein, particularly when using stable toroidal flows. As illustrated, the 1-hour, 2 hours, and 3 hours reaction times produce expanded graphite materials with the lowest ratio of the intensity of the D band peak to the intensity of the G band peak, whereas the commercial expandable graphite has a higher ratio of the intensity of the D band peak to the intensity of the G band peak, indicating more structural defects.

In some instances, increasing wavenumber of G band (about 1587 cm-1) corresponds with number of graphenic layers or sheets in a graphenic compound (e.g., with increasing intensity corresponding with increasing layers). In certain instances, increasing intensity of D band (about 1350 cm-1) corresponds with increasing graphitic/graphenic defect. In some instances, the 2D band (about 2700 cm-1) corresponds with stacking and decreases with increasing exfoliation. In certain instances, with decreasing intensity (area) of the D band relative to the G band (I_{D}/I_{G}) the structural deformities are reduced (e.g., with natural graphite, and expanded graphite as disclosed herein processed for 1 to 3 hours having an I_{D}/I_{G} of about 0). As illustrated in FIG. 7, various expanded graphite compounds and compositions are produced by various exemplary iterations provided herein. In some embodiments, provided herein is an expanded graphite compound (e.g., expanded graphite) or composition having (e.g., average) I_{D}/I_{G} of less than 1.0, such as less than 0.5, less than 0.25, less than 0.05, or the like. In exemplary embodiments, I_{D}/I_{G} is less than 0.05. In other exemplary embodiments, the I_{D}/I_{G} ratio is about those illustrated in FIG. 7.

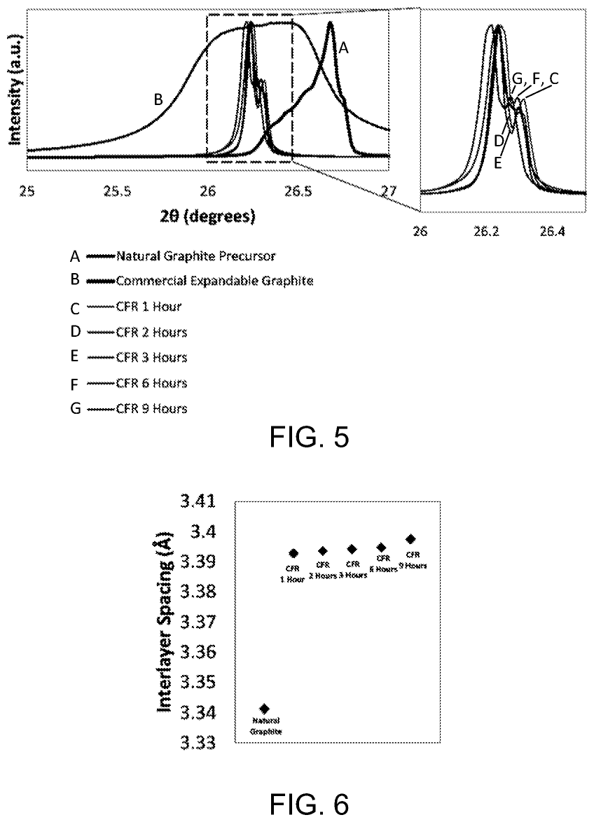

FIG. 6 illustrates the different interlayer spacing of the expanded graphite compounds prepared using the various types of flows described herein. In certain embodiments, the interlayer spacing is determined based on Bragg's law. As illustrated, natural Graphite has very low interlayer spacing, whereas all of the expanded graphite materials prepared according to a process described herein, using the various flow types described herein, produce expanded graphite compounds having an interlayer spacing of about 3.39 Å to about 3.41 Å (compared to less than 3.35 Å for graphite).

FIG. 5 illustrates X-ray diffraction (XRD) peaks for commercial expandable graphite, natural graphite, and expanded graphite compounds and compositions produced using processes and flows described herein. As shown in FIG. 5, chemically expanded (e.g., or commercially expanded or expandable) has a broad peak expanding from a two-theta (2θ) value of about 25° to about 28°, illustrating structural inhomogeneity and defects. The expanded graphite compounds and compositions produced using processes and flows described herein have narrower peaks, ranging in 2θ values from 25° to 27°, but where at least 60% (e.g., at least 70%, at least 80%, at least 85%, at least 90%, at least 95%, at least 98%) of the area under the curve for the X-ray diffraction peak or peaks is within 0.5°. For example, at least 60% (e.g., at least 70%, at least 80%, at least 85%, at least 90%, at least 95%, at least 98%) of the area under the curve for the X-ray diffraction peak or peaks having a two-theta (2θ) between 25° and 27° is between 26° and 26.5° (e.g., 26.1° and 26.4°). Expanded graphite compounds and compositions produced using processes and flows described herein also have X-ray diffraction peaks with lower two-theta (2θ) values than natural graphite (e.g., natural flake or synthetic graphite) the expanded graphite having a two-theta (2θ) (e.g., max) peak value of about 26.2-26.4°, such as about 26.2-26.3°).

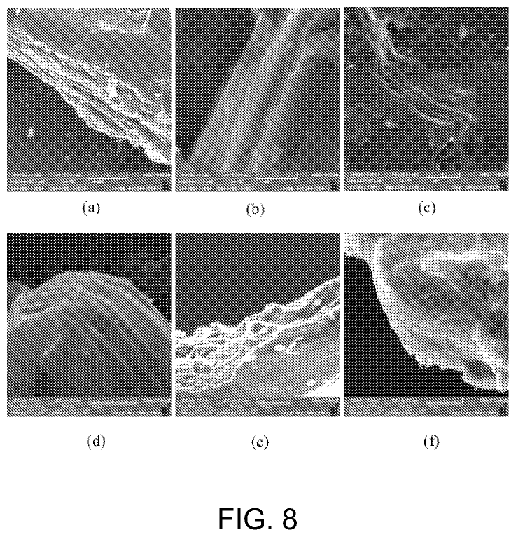

In some embodiments, expanded graphite compounds described herein and/or produced according to a process described herein have an average interlayer spacing of about 3.35 Å to about 3.45 Å, such as about 3.39 Å to about 3.41 Å. FIG. 8 further illustrates the comparison of commercial expandable graphite with expanded graphite materials prepared according to processes described herein. FIG. 8 (a) represents scanning electron microscope (SEM) imagery of natural graphite. FIG. 8 (b)-(f) represents expanded graphite materials prepared according to processed described herein.

In some embodiments, the gap width and the shear rate of the manufacturing process described herein can be changed to yield expanded graphite of different surface area. FIG. 20 illustrates varying inner cylinder radius and gap. FIG. 16 illustrates the results from four different shear rates on the surface area of exemplary expanded graphite. In some instances, lower shearing forces result in breaking natural graphitic particles into smaller expanded graphite materials. In certain instances, at higher shear rates, flow instability results in agglomeration of expanded graphite material. In comparison, a shear rate of about 3.2×10⁴ s⁻¹ resulted in breaking down of natural graphitic particles into even smaller expanded graphite materials for exfoliation without aggregation of the expanded graphite

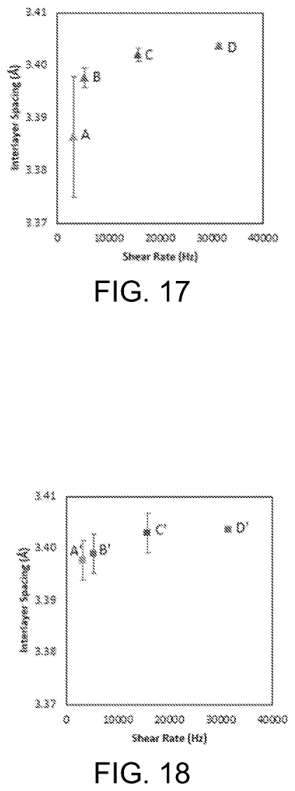

FIG. 17 illustrates the interlayer spacing of exemplary expanded graphite under different shear rates. As shown in FIG. 17, increasing the shear rates results, in some instances, in increasing interlayer spacing between the graphene sheets of the exemplary expanded graphite.

In certain embodiments, the rotation speed of the cylindrical inner surface and/or outer surface can be varied. FIG. 18 illustrates the same shear rates as FIG. 17 with a change of rotation speed and a constant narrow gap. The resulting exemplary expanded graphite follows the same trend as FIG. 17 with an increase of interlayer spacing between graphene sheets with increasing shear rate.

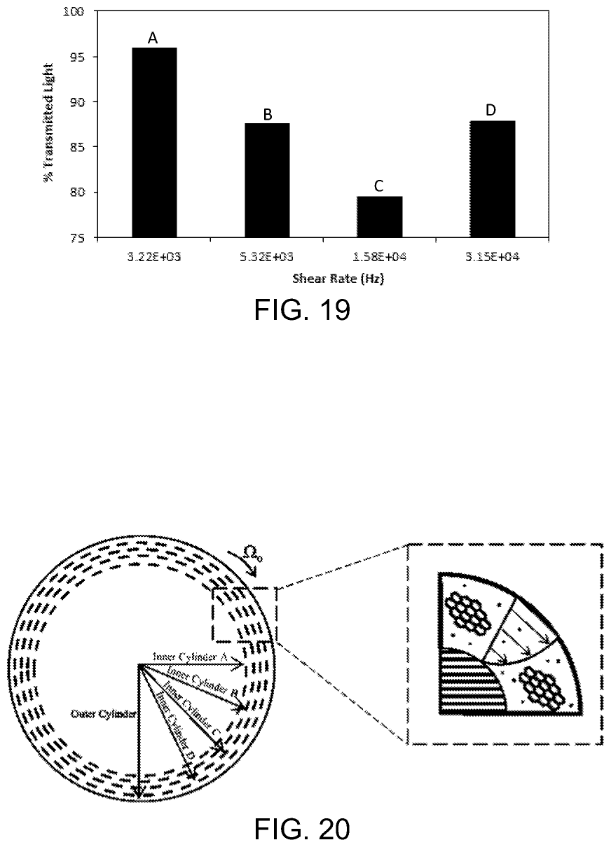

FIG. 19 illustrates the % transmitted light of exemplary expanded graphite manufactured at different shear rates and gap width. As gap size becomes smaller, the flow condition moves from turbulent to laminar, the size distribution of the expanded graphite becomes less uniform. Increased curvature induces turbulent conditions, which are sufficient to break down the graphite particles in a uniform manner as seen in FIG. 16. FIG. 19 shows the capability of tuning the % transmitted light of the exemplary expanded graphite with changes in levels of exfoliation, aggregation, and size uniformity.

In certain embodiments, effectively dispersed exemplary expanded graphite solution provided by manufacture process herein have a zeta potential about −40 mV to about −30 mV. In certain embodiments, the solution comprises of dispersant such as a polymer (e.g., Pluronic F127), a stabilizer (e.g., xanthan gum), water, and the precursor natural graphite or exemplary expanded graphite. In specific embodiments, the solution of precursor natural graphite, water, dispersant, and stabilizer measured a zeta potential of about −8 mV. In specific embodiments, the solutions of expanded graphite through processing described herein, water, dispersant, and stabilizer measured zeta potentials of about −40 to about −30 mV.

In certain embodiments, provided herein are carbon fibers (e.g., comprising high aspect ratio graphene sheets therein, such as being substantially aligned along the length of the fiber) produced from expanded graphite (e.g., such as described herein). For example, expanded graphite may be pulled from processes as described herein in a fluid stock and may be loaded into a syringe and injected into a coagulation bath. The coagulation bath may include water and/or ethanol. The obtained fibers may be wound and soaked in a washing bath, such as a washing bath with water and ethanol in a 1:1 ratio, before being dried.

In some embodiments, carbon fibers provided herein comprise an expanded graphite (e.g., such as described herein) component, a liquid medium, and an optional polymer. In certain embodiments, a carbon fiber provided herein is less than 90 wt. % polymer. In specific embodiments, the fiber is less than 80 wt. % polymer. In more specific embodiments, the fiber is less than 60 wt. % polymer. In still more specific embodiments, the fiber is less than 40 wt. % polymer. In more specific embodiments, the fiber is less than 20 wt. % polymer. In still more specific embodiments, the fiber is less than 10 wt. % (e.g., less than 5 wt. %, less than 2 wt. %, or the like) polymer. In various embodiments, any suitable polymer is used in a fiber, filament, stock, process, etc. described herein. In specific embodiments, the polymer is polyvinyl alcohol (PVA), polyethylene oxide (PEO), polyacrylonitrile (PAN), nylon, polyvinylidene difluoride (PVDF), polyvinylpyrrolidone (PVP), or any combination of one or more of such polymers.

In certain embodiments, the fibers provided herein have good strength with relatively low density.

In various embodiments, fibers provided herein have any suitable diameter. In some embodiments, fibers herein have a diameter comparable to the diameter of a commercial carbon fiber. In various embodiments, processes provided herein provide a great deal of control over filament and fiber sizes. In various embodiments, large or small fibers, such as up to hundreds of microns down to fractions of microns are optionally provided. In specific embodiments, a fiber provided herein has an average diameter of about 100 micron or less. In more specific embodiments, a fiber provided herein has an average diameter of about 50 micron or less. In more specific embodiments, a fiber provided herein has an average diameter of about 25 micron or less. In certain embodiments, a fiber provided herein has an average diameter of about 0.2 micron or more. In specific embodiments, a fiber provided herein has an average diameter of about 0.5 micron or more. In more specific embodiments, a fiber provided herein has an average diameter of about 1 micron or more. In some embodiments, a fiber provided herein has an average diameter of about 5 micron to about 20 micron. In alternative embodiments, a fiber provided herein has an average diameter of about 1 micron to about 10 micron. In certain instances, carbon nanofibers (e.g., having a diameter of less than 5 micron, less than 2 micron, or the like) are produced by any suitable process, such as a process described herein, e.g., wherein a stock is spun into a liquid medium (e.g., wet spinning). In some instances, larger carbon nanofibers (e.g., having a diameter of at least 2 micron, at least 5 micron, at least 10 micron, about 10 micron to about 50 micron, or the like) are prepared by any suitable process, such as by a process described herein wherein a stock is spun into a liquid medium (e.g., wet spinning).

In certain embodiments, fibers have good performance characteristics, such as low brittleness and high strength (particularly, relative to mass and/or density, such as a density described herein). In certain embodiments, provided herein are fibers having a tensile strength of at least 1 MPa. In specific embodiments, fibers provided herein have a tensile strength of about 100 MPa or more. In more specific embodiments, fibers provided herein have a tensile strength of about 200 MPa or more. In still more specific embodiments, fibers provided herein have a tensile strength of about 300 MPa or more. In yet more specific embodiments, fibers provided herein have a tensile strength of about 400 MPa or more. In yet more specific embodiments, fibers provided herein have a tensile strength of about 500 MPa or more. In some embodiments, fibers provided herein have a tensile strength of about 200 MPa to about 500 MPa, such as illustrated in FIG. 11.

In certain embodiments, fibers provided herein have any suitable diameter (e.g., on average). In some embodiments, the fibers have a diameter that is small enough to reduce or minimize shell/core effects (e.g., the effect where the shell and the core have significantly different performance characteristics, particularly wherein the shell performance characteristics are significantly better than those of the core). In certain embodiments, a fiber (filament) provided herein has an average diameter of about 5 micron or less. In specific embodiments, provided herein is a fiber that has an average diameter of about 2 micron or less. In more specific embodiments, provided herein is a fiber that has an average diameter of about 20 nm to about 2 micron.

Provided in certain embodiments herein are process for preparing a fiber described herein. In specific embodiments, provided herein is a process for preparing a carbon fiber, such as described herein. In more specific embodiments, the process comprises:
a. providing a fluid stock, the fluid stock comprising an expanded graphite component and a liquid medium;
b. injecting the fluid stock with or into one or more fluid medium (e.g., a coagulant bath); and collecting carbon fibers.

In some embodiments, injection of the fluid stock into the one or more fluid medium (e.g., coagulant) provides one or more fiber. In certain embodiments, one or more fluid stock is injected with or into a plurality of liquid mediums (e.g., coagulant baths), such as with a plurality of nozzles. In other embodiments, a single nozzle produces a plurality of fibers, a fiber mat, or a long or continuous fiber. Such instances wherein a plurality of fiber segments are bundled are included in the iterations of bundling a “plurality of fibers” described herein.

In some embodiments, provided herein is a process for manufacturing a carbon fiber, the process comprising:
a. providing a fluid stock, the fluid stock comprising an expanded graphite component and a liquid medium;
b. injecting the fluid stock with or into one or more fluid medium (e.g., liquid medium);
c. and collecting carbon fibers.

In various embodiments, the fluid stock is provided to the nozzle at any suitable flow rate, such as about 0.01 mL/min or more, about 0.05 mL/min or more, about 0.1 mL/min or more, about 0.2 mL/min or more, or about 0.01 mL/min to about 10 mL/min. In certain embodiments, the fluid stock is provided to the (e.g., first) inlet at a rate of about 0.01 mL/min to about 10 mL/min, e.g., about 0.05 mL/min to about 5 mL/min, or about 0.5 mL/min to about 5 mL/min.

In certain embodiments, provided herein is a composition comprising a liquid medium or solvent and a fiber provided herein (e.g., a coagulation bath comprising a fiber and fluid medium, such as a flowing fluid medium). In some instances, the fiber comprises a polymer. In certain instances, the polymer is not soluble in the fluid medium. In other embodiments, the polymer is at least partially soluble in the fluid medium, at least partially removing polymer from the fiber. In certain embodiments, a composition provided herein comprises a fluid medium and a fiber provided herein, and a polymer (e.g., dissolved in the fluid medium). Any suitable fluid medium or solvent is optionally utilized, such as water, alcohol (e.g., methanol, alcohol, propanol, or the like), alkane (e.g., heptane), haloalkane (e.g., dichloromethane or chloroform), benzene, toluene, xylene, or the like. In preferred embodiments, the fluid medium comprises water and/or ethanol.

In some embodiments, the fluid medium is a liquid medium, such as a coagulation bath (e.g., wherein the process is known as “wet spinning”). In certain embodiments, the liquid medium is an aqueous medium. In some embodiments, the liquid medium (e.g., aqueous medium) comprises a surfactant or salt. In specific embodiments, the surfactant is an ionic (e.g., cationic) surfactant. In specific embodiments, the ionic surfactant comprises a hydrocarbon group, such as a fatty alkyl (e.g., an alkyl comprising from 6-26 carbons, 10-26 carbons, 14-22 carbons, or the like). In some embodiments, the ionic surfactant comprises a carboxylate, a sulphonate, a sulphate, a quaternary ammonium, or a phosphate. In specific embodiments, the ionic surfactant comprises a quaternary ammonium group. In some embodiments, exemplary surfactants comprising a fatty alkyl group and a quaternary ammonium include, by way of non-limiting example, hexadecyltrimethylammonium bromide (CTAB), dodecyltrimethylammonium bromide (DTAB), distearyldimethylammonium chloride, and diethyl ester dimethyl ammonium chloride.

In certain embodiments, the liquid medium is heated, such as to a temperature of about 30° C. or more. In specific embodiments, the liquid medium has a temperature of about 30° C. to about 60° C. In more specific embodiments, the liquid medium has a temperature of about 40° C. to about 55° C.

In some embodiments, fibers produced in a process herein are further chemically and/or thermally treated, such as to reduce and/or pyrolyze the expanded graphite and/or polymer components thereof. In certain embodiments, the fiber is thermally treated. In some embodiments, the fiber is thermally treated at a temperature suitable for fusing adjacent graphenic components to form a longer graphenic component (e.g., graphene). In certain embodiments, the fiber is thermally treated under conditions suitable for carbonizing the polymer to a non-graphenic carbon (e.g., amorphous and/or graphitic carbon) (e.g., at elevated temperature under inert or reductive conditions). In some embodiments, the fiber is thermally treated under conditions suitable for removing or reducing the amount of non-graphenic component (e.g., polymer) present in the fiber.

In some instances, other reductive techniques (e.g., chemical techniques) are employed in the alternative or in addition to thermal treatment techniques. In certain embodiments, expanded graphite components of fibers provided herein (e.g., post-reductive treatment) have a low oxygen content, such as less than 5 wt. %. In some embodiments, carbon fibers provided herein are less than 3 wt. % oxygen. In specific embodiments, carbon fibers provided herein are less than 1 wt. % oxygen. In more specific embodiments, carbon fibers provided herein are less than 0.5 wt. % oxygen. In still more specific embodiments, carbon fibers provided herein are less than 0.2 wt. % oxygen.

In some embodiments, thermal treatment provides a fused graphenic component, such as wherein a plurality of graphenic components of the expanded graphite in the spun stock are fused together along the length of the fiber, such as forming a continuous or high aspect ratio graphenic component within the fiber, such as wherein the graphenic component has an aspect ratio (length/width) of at least 10, at least 50, at least 100, or the like. In certain embodiments, a stock or non-fused graphenic sheets of the expanded graphite component provided herein has a lateral dimension (e.g., length or longest dimension) of at least 10 micron (μm), at least 15 micron, or, more preferably, at least 20 micron. In some embodiments, the fused graphenic component provided herein has a lateral dimension (e.g., length or longest dimension) of at least 100 micron, at least 200 micron, at least 500 micron, at least 1 mm, at least 2 mm, at least 5 mm, or the like.

In some embodiments, the graphitic component (e.g., expanded or exfoliated graphite or graphite particles) provided herein has a surface area of at least 25 μm², at least 30 μm², at least 35 μm², about 38 μm², or the like.

In certain embodiments, fibers provided herein (e.g., post thermal treatment) comprise graphenic components with high aspect ratios and/or low defects. In some instances, high aspect ratio graphenic components are substantially aligned with the fiber construct (e.g., as graphenic components thereof are fused during thermal treatment to produce one or more higher aspect ratio graphenic component (e.g., with reduced oxygen content and/or fewer defects)). In certain embodiments, the aspect ratio of a graphenic component herein is at least 1.5 times, at least 2 times, at least 3 times, at least 5 times, at least 10 times, at least 25 times, at least 50 times, or more as large as the aspect ratio of the graphenic component prior to thermal treatment.

In certain embodiments, provided herein is a fluid stock comprising an expanded graphite component. In more specific embodiments, the fluid stock comprises an expanded graphite component and a polymer. In some embodiments, high concentrations of expanded graphite component relative to polymer is desired, such as to improve yield of carbon fibers if and when polymer is removed and/or carbonized. In certain embodiments, the weight ratio of expanded graphite component to polymer present in a fluid stock herein is at least 1:10. In preferred embodiments, the weight ratio of expanded graphite component to polymer is at least 1:8. In specific embodiments, the weight ratio of expanded graphite component is about 1:6. In more specific embodiments, the weight ratio of expanded graphite component is about 1:5. In still more specific embodiments, the weight ratio of expanded graphite component is about 1:4. In yet more specific embodiments, the weight ratio of expanded graphite component is about 1:3. In certain embodiments, the weight ratio of expanded graphite component is up to about 1: 1, or more.

In addition, in some embodiments, high loading of the expanded graphite component and polymer in the fluid stock is desired, such as to improve throughput, fiber uniformity, fiber continuity, and performance characteristics. Generally, such high loading of inclusion materials into the fluid stock results in high viscosities in the stocks, which are difficult or impossible to extrude or spin using conventional techniques.

In specific embodiments, a process described herein comprises providing a fluid stock to a first inlet of a first conduit of a nozzle, the first conduit being enclosed along the length of the conduit by a wall having an interior surface and an exterior surface, the first conduit having a first outlet. In specific instances, the walls of the first conduit form a capillary tube, or other structure. In some instances, the first conduit is cylindrical, but embodiments herein are not limited to such configurations.

In preferred embodiments (e.g., wherein the stock is spun into a liquid medium—“wet spinning”), a fluid stock is spun, injected, ejected, or otherwise processed through a needle or conduit having an internal cross-sectional diameter or width of less than 3 mm, such about 2.5 mm or less, about 2.0 mm or less, or about 1.5 mm or less. In some instances, the conduit has an internal cross-sectional diameter of about 0.4 mm, such about 0.35 mm or less, about 0.3 mm or less, or about 0.25 mm or less. In certain embodiments, smaller needles are preferred, such as to provide a small enough amount of material to form a consistent fiber size upon spinning and coagulation, such as in a coagulation bath.

In various embodiments, any suitable bulk material is utilized herein, such as thermoplastic, a resin, a metal, or the like. In specific embodiments, the bulk material is epoxy, polyether ether ketone (PEEK), phenolic resin, or the like.

In various embodiments, composites provided herein are used in aerospace, automotive, civil engineering, optical electromagnetic shielding films (e.g., over 80% % transmitted light) or other applications. Provided herein are airplanes, helicopters, space-craft, automobiles (cars, trucks, etc.) comprising such composites. In various embodiments, such composites are used in the frame, fuselage, body, blades, or the like of such vehicles.

### EXAMPLES

### Example 1—Materials

Natural graphite powders from Asbury Carbon (3061). Xanthan gum (CAS# 11138-66-2) and Ethanol from VWR used as provided as a stabilizing agent. Pluronic F127 (F127) (CAS#9003-11-6), PEO:PPO:PEO=100:65:100 from BASF is used as a dispersant. Cetyl trimethyl ammonium bromide (CTAB, CAS# 57-09-0) used from Sigma. Deionized (DI) water is used during all syntheses.

### Example 2—Expanded Graphite: Batch-System Couette Flow Reactor (CFR)

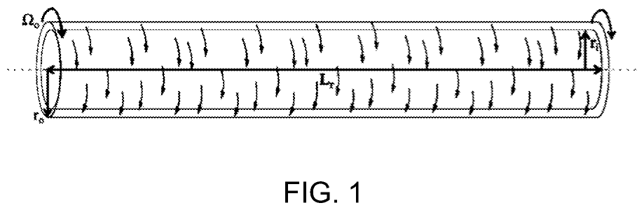

The experimental setup of the CFR, illustrated in FIG. 1, consists of two coaxial cylinders, with the outer one (plexiglass) rotating while the inner one (stainless steel) is still. The outer cylinder rotation rate, as illustrated in FIG. 4, is controlled by a phase inverter, connected to a motor drive that provides rotation rates in the range of 10-1800 rates per minute (RPM). Table 1 includes the physical specifications of the CFR, where rₒ and r₁ are the outer and inner cylinder radii, respectively, d is the corresponding gap width, and Lᵣ is the length of the CFR. The CFR system is driven through the rotation of the outer cylinder, which is quantified in dimensional form of the outer cylinder's angular velocity Ωₒ and in dimensionless form by the Reynolds number Reₒ using the kinematic viscosity of the Newtonian fluid between the two cylinders.

$${Re}_{o} = \frac{{r}_{o} {Ω}_{o} d}{v} \qquad ( Equation 1 )$$

TABLE 1
Dimension of the Couette flow reactor,

| rᵢ (cm) | rₒ (cm) | d (rₒ − rᵢ) (cm) | Lᵣ (cm) |
|---|---|---|---|
| 2.46 | 2.54 | 0.08 | 30.48 |

Natural graphite (20 g) was suspended in 200 mL of DI water and the obtained solution is stirred for 10 minutes. 0.6 g of F127, as described in Example 1, is slowly added to the mixture and the stirring continues for 10 minutes. The mixture solution is introduced into the gap between the two cylinders in a stationary CFR. The rotation speed is fixed at 1500 RPM. The rotation of the outer cylinder while the inner cylinder is stationary induces high wall shear stress, which eases the penetration of the dispersant and stabilizing agent particles into the interlayer spacing of the graphene sheets. The residence time in the CFR is varied between 1 to 9 hours. The observed color of the mixture is dark grey and under-expanded natural graphite flakes are suspended in the solution. The resulting mixture (expanded graphite stock) is centrifuged at 2000 rpm for 90 min, where the under-expanded natural graphite flakes will sediment. Air-controlled electrospray is applied for directly depositing the centrifugate on silicon wafers (25.4 mm diameter, 400 μm thickness, University Wafer). The electrospray is performed under ambient conditions using a Harvard Apparatus PHD 2000 Infusion syringe pump with a coaxial needle set. Expanded graphite solution is supplied through the inner 17 G needle and air is supplied through the outer 12 G needle. The working voltage is set at 25 kV, working distance at 15 cm, solution feeding rate at 0.05 mL/min, air pressure at 20 psi, and total 2 mL of sprayed material. The sprayed wafers are dried using a vacuum over at 45° C.

X-ray diffraction (XRD) patterns of electrosprayed expanded graphite samples are determined by a D8 Advance ECO powder diffractometer (Bruker Corporation) using a high-brilliance 1 kW X-ray source. The microstructures of the graphene sheets are investigated using inVia confocal Raman microscopy (Renishaw) with a 488 nm laser beam. Scanning electron microscopy (SEM) is performed using a MIRA 3 FEG-SEM (Tescan). Optical microscope images were obtained using 40X-2000X Professional Infinity Trinocular Compound Microscopy with 14MP Camera (AmScope). For sample characterization, the collected expanded graphite solution is centrifuged at 2000 rpm for 90 minutes to allow for the sedimentation of under-expanded natural graphite particles. The centrifugate is collected and electrosprayed on silicon wafers.

As illustrated in FIG. 5, XRD analysis is used to study the effect of the Couette flow regime on the expansion of graphene sheets. FIG. 5 compares XRD patterns for the samples with respect to residence time in CFR. The main graphenic XRD peak corresponds to the interlayer spacing according to Bragg's law. Natural graphite has the main peak at 26.66° 2θ corresponding to the interlayer spacing of 3.34 Å. Commercial expandable graphite has a broad peak expanding between about 25° to about 28°. The broad commercial expandable graphite XRD spectrum can be deconvoluted to a number of smaller peaks that correspond to interlayer spacing spanning between ˜3.35 Å and ˜3.43 Å. This confirms the structural inhomogeneity in the commercial expandable graphite sample that contains graphite flakes with varying interlayer spacing. After expanding natural graphite to synthesize expanded graphite, the main XRD peak shifts toward the left with longer residence time in CFR. The narrow XRD peaks suggest the structural homogeneity in the synthesized expanded graphite samples. All XRD peaks are narrow-shaped suggesting the stacking structure of the natural graphite precursor is preserved. FIG. 6 shows the increasing interlayer spacing between graphene sheets from about 3.34 Å to about 3.40 Å based on Bragg's law.

Raman spectroscopy is used to investigate structural defects on the synthesized graphene sheets of the expanded graphite. Energy shift caused by laser excitation creates main Raman peak positions: D band (1350 cm-1), G band (1570 cm-1), and 2D band (2700 cm-1). Exposing natural graphite flakes to strong Couette fluid flow result in structural changes in the graphite lattice that result in a higher intensity of the D band. FIG. 7 shows the Raman spectra (Excitation Laser=488 nm) of natural graphite precursor, commercial expandable graphite, and CFR synthesized expanded graphite samples. It shows that the natural graphite precursor and the synthesized expanded graphite samples with residence time between 1 and 3 hours have almost no defects on the graphene sheets. Raman spectra of the expanded graphite samples with 6 and 9 hours residence time and the commercial expandable graphite reveal the presence of structural defects on the graphene sheets. The I_{D}/I_{G} ratio is used to determine the defect level and increases with increasing defect levels. The I_{D}/I_{G} ratio of natural graphite (about 0.0 to about 0.05) indicates the low defect level in graphite particles. We note that the I_{D}/I_{G} ratio of synthesized expanded graphite samples at residence times between 1- and 3 hours remain at the same or similar levels as the I_{D}/I_{G} ratio of natural graphite precursor. The I_{D}/I_{G} ratio starts increasing after 6 hours (I_{D}/I_{G}=0.48) and 9 hours (I_{D}/I_{G}=0.48) due to the exposure of high shear rate at extended residence times in the CFR.

SEM micrographs of the commercial expandable graphite and synthesized expanded graphite flakes are shown in FIG. 8. The representative micrographs showed how the graphite layers in the synthesized expanded graphite samples have expanded and the layer distance has been enlarged. FIG. 8(a) is comparable to FIG. 8(b)-(f) in terms of the expanded graphene layered structure. This confirms the morphological similarity between the commercial expandable graphite and synthesized expanded graphite samples that includes well-marked separation of the expanded layers.

### Example 3—Dispersion Control

Naturally graphite does not disperse well in aqueous solutions, a well dispersed solution is needed to apply maximum shear force for exfoliation. The graphite solution as described in Example 1 (e.g., natural graphite, dispersant (Pluronic F12), stabilizer (xanthan gum), and water) prior to CFR processing has a zeta potential of about −8 mV. The synthesized expanded graphite samples as described in Example 2 can result in varying levels of structure defects, expansion / exfoliation, and oxidation based on CFR processing times (e.g., 1-hour, 3 hours, 6 hours, and 9 hours). The 1- and 3 hour CFR resulted in a zeta potential of about −40 mV. The 6 and 9 hours CFR resulted in a zeta potential of about −35 mV and of about −30 mV, respectively. The zeta potential of exemplary expanded graphite solutions is lower than natural graphite solution, demonstrating good dispersion of expanded graphite in the solution. The decrease in zeta potential with longer CFR processing can be attributed to the increased concentration of synthesized expanded graphite in the solution and resulting in a decrease of repulsive forces displayed by expanded graphite.

### Example 4—Carbon Fibers

The expanded graphite stock of Example 2 is loaded in a plastic syringe and injected into a rotating CTAB coagulation bath (0.5 wt % in water: ethanol 1:1; and 15 RPM) with the infusion rate of 0.75 mL/min. The obtained fibers remained in the bath for 30 minutes before winding around a Teflon bar, and then soaked the bar in a washing bath (1:1 volume ratio of water and ethanol) for another 60 minutes. The fiber then is dried at room temperature after taking out from the bath.

### Example 5—Carbon Fibers: Wet Spinning

Wet spinning is used to fabricate carbon fibers from the expanded graphite. FIG. 10 illustrates the tensile strength of carbon fibers spun from commercial expandable graphite. FIG. 11 illustrates the tensile strength of carbon fibers spun from synthesized expanded graphite compounds as described herein. When expanded graphite dispersion is used as the source solution for the carbon fibers, they are stronger than the carbon fibers spun from commercial expandable graphite, and had Young's moduli as high as 35 GPa. This observation reveals the importance of the flake size on the final fiber properties.

For synthesized expanded graphite fibers, different times of exfoliation were compared with each other. Starting from 1-hour of exfoliation up to 3 hours of exfoliation seemed to increase the fiber strength followed by a decrease when going to 6 and 9 hours of exfoliation. The trend is in line with what was observed in the Raman spectroscopy, shown in Example 2, of the solutions before spinning.

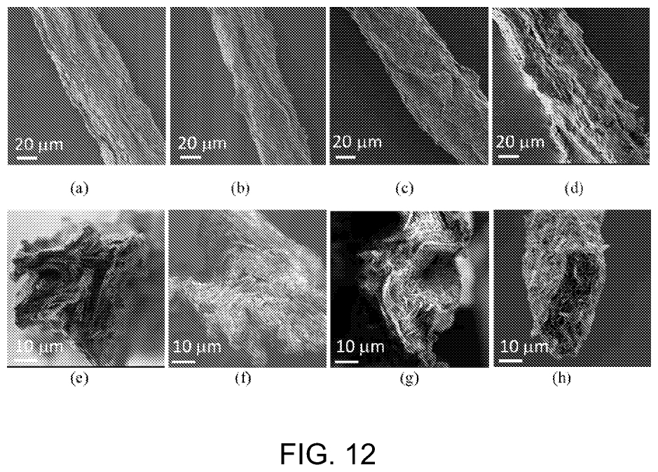

Morphology of the carbon fibers is investigated by SEM, as illustrated in FIG. 12. As shown in FIG. 12, the carbon fibers produced from the synthesized expanded graphite (a, b, c, e, f, and g) possess more packed morphology than carbon fibers produces from commercial expandable graphite (d, and h).

### Example 6—Carbon Fiber Formation: Coagulation Bath

The expanded graphite stock of Example 2 is wet-spun or extruded through a spinning nozzle into a (e.g., flowing) fluid. The spun fluid stock provides nanofibers within the fluid bath, the flowing nature of the bath and/or the winding collector serving to draw the fibers into a unidirectional manner, resulting in the alignment and (non-twisted) bundling thereof. The fluid bath of the liquid medium facilitates removal of any residual fluid from the expanded graphite stock, enhancing fiber formation.

### Example 7—Wet Spinning Surfactant

Using a process similar to that in Example 6, expanded graphite stocks are spun into a variety of liquid mediums. Various salts and solvents are utilized to form the coagulation bath/liquid medium. Salts, such as calcium chloride or sodium hydroxide, and surfactants, such as quaternary ammonium surfactants are dissolved or suspended in the solvent. When spinning into a bath comprising ethyl acetate with a salt, poor fiber formation is observed. Better results are observed when an aqueous solution is utilized with the salt, but a consistent, continuous fiber is not observed. Even better fiber formation is observed when using a mixture of water and ethanol with the salt, but upon slight shaking of the sample, the fibers disintegrate. When using an aqueous ionic surfactant (quaternary ammonium) bath, however, very good results are obtained, collecting a continuous carbon fiber.

### Example 8—Wet Spinning Temperature

Using a process similar to that in Example 6, expanded graphite stocks are spun into an aqueous bath comprising ionic surfactant, the bath being held constant at a given temperature.

Bath temperatures included room temperature, 40° C., 50° C., and 60° C. When spinning into a room temperature bath and collecting the fiber on a graphite rod, large fibers are formed, but such fibers are difficult to remove from the graphite rod following drying. When spinning into a bath held at 40° C., the fibers are well formed and collected (rolled) onto a graphite rod. Following drying, the fibers are readily removed from the rod. Similar results are obtained when using a 50° C. bath, with improved ability to separate overlapping fibers from one another. Results similar to those obtained at 50° C. were obtained in the 60° C. bath, but the resultant fibers are more brittle and difficult to handle.

### Example 9—Wet Spinning Conduit Size

Using a process similar to that in Example 6, expanded graphite stocks are spun into an aqueous bath comprising ionic surfactant. The spinning nozzle is varied, using a 22 gauge needle (−0.413 mm) and a 27 gauge needle (−0.21 mm). The fibers are collected, (room temperature) dried, and thermally treated (annealed). The larger needle (22G) produces larger nanofibers following both drying and thermal treatment, with the dried fibers having a size of about 70 micron to about 105 micron and the annealed fibers having a size of about 40 micron to about 90 micron. The smaller needle (27G) produces smaller nanofibers following both drying and thermal treatment, with the dried fibers having a diameter of about 30 micron and the annealed fibers having a size of about 20 micron. Use of the smaller nozzle conduit produces fibers with much more consistent and uniform fibers (e.g., size) along the length of the fiber both after drying and after annealing.

### Example 10—Reactor Parameters for Tuning Expanded Graphite

Using parameters similar to those described in Example 6, various parameters (e.g., gap, shear rate, rpm, and the like) were varied and evaluated for impact on tuning expanded graphite materials. The gap size between the inner cylinder and outer bore can be used to change the shear rate. Decreasing the gap size by changing the inner cylinder can be seen in FIG. 20. A smaller gap size results in an increased curvature of flow and shear rate. The flow conditions with smaller gap size moves from turbulent to laminar flow. The shear rate plays a role in the amount of surface area of the expanded graphite. Low shear rates (inner cylinder A and B in FIG. 20; data points A (3.14×10³ s⁻¹) and B (5.24×10³ s⁻¹) of FIG. 16) result in turbulent conditions and breaking the natural graphite into smaller graphitic particles for exfoliation. Higher shear rates (inner cylinder C in FIG. 20; data point C (1.57×10⁴ s⁻¹) of FIG. 16) as a result of smaller gap width lead to a flow regime with flow instability causing agglomeration of expanded graphite materials. In comparison, the surface area of A and B is smaller than C as a result of the shear rate as seen in FIG. 16. At the highest shear rate (inner cylinder D in FIG. 20; data point D (3.14×10⁴ s⁻¹) of FIG. 16) and the smallest gap width resulted in laminar flow conditions. The highest shear rate results in breaking down the natural graphitic particles into smaller expanded graphite materials and allow exfoliation without aggregation, such as conditions at 1.57×10⁴ s⁻¹. The surface area of D is smaller than C as a result of shear rate as see in in FIG. 16.

The corresponding experimental processes herein FIG. 16 and FIG. 20 is also reproduced in FIG. 17 (e.g., decreasing gap width for increasing shear rate). As seen in FIG. 17, an increase in shear rate results in an increase in interlayer spacing between the graphene layers of the exemplary expanded graphite materials. At the lower shear rate (A) led to about 3.39 Å and higher shear rates of B, C, and D led to about 3.40 Å with an average of about 3.40 Å of the four different shear rates.

As seen in Equation 1, the rotation of the cylindrical bore influences the Reynolds number and shear rate. With keeping the shear rates the same as FIG. 16 and FIG. 17 and maintaining the gap size narrow (inner cylinder D in FIG. 20) constant, but changing the rotation speed, the resulting interlayer spacing of the expanded graphite materials maintain an average of about 3.40 Å as seen in FIG. 18. The narrow gap improves the exfoliation level due to flow curvature and laminar Couette flow, regardless of the shear rates, as seen in Table 2.

TABLE 2
Varying Rotation Speeds and Flow Characteristics
of Taylor-Couette reactor.

| Flow | Rotation speed | Shear rate | |
|---|---|---|---|
| regime | (RPM) | (s⁻¹) | Re₀ |
| A′ | 150 | 31.4 × 10² | 47 |
| B′ | 250 | 52.4 × 10² | 76 |
| C′ | 750 | 157 × 10² | 227 |
| D′ | 1500 | 314 × 10² | 454 |

What is claimed is:

1. An expanded graphite comprising a plurality of graphene sheets, the plurality of graphene sheets having an average interlayer spacing between the graphene sheets of at least 3.35 Å (e.g., 3.35 Å to about 3.45 Å).

2. The expanded graphite of claim 1, wherein the average interlayer spacing between the graphene sheets is about 3.39 Å to about 3.41 Å (e.g., about 3.4 Å).

3. The expanded graphite of any one of the preceding claims, wherein the expanded graphite has an X-ray diffraction peak or peaks having a two-theta (2θ) between 25° and 27°, and wherein at least 60% (e.g., at least 70%, at least 80%, at least 85%, at least 90%, at least 95%, at least 98%) of the area under the curve for the X-ray diffraction peak or peaks having a two-theta (2θ) between 25° and 27° is between 26° and 26.5° (26.1° and26.4°).

4. The expanded graphite of any one of the preceding claims, wherein the expanded graphite has an X-ray diffraction peak or peaks having a two-theta (2θ) between 25° and 27°, and wherein at least 60% (e.g., at least 70%, at least 80%, at least 85%, at least 90%, at least 95%, at least 98%) of the area under the curve for the X-ray diffraction peak or peaks having a two-theta (2θ) between 25° and 27° is within a 0.5° (e.g., 0.4°, 0.3°, 0.25°, or 0.2°) range.

5. The expanded graphite of any one of the preceding claims, wherein the expanded graphite has a narrower XRD two-theta (2θ) peak than chemically expanded (e.g., or commercially expanded or expandable) graphite having a peak between a two-theta (2θ) value between 25° and 27°.

6. The expanded graphite of any one of the preceding claims, wherein the expanded graphite has a lower XRD two-theta (2θ) peak value than natural graphite having a two-theta (2θ) peak value (e.g., the graphite having a two-theta (2θ) (e.g., max) peak value of about 26.2-26.4, such as about 26.2-26.3).

7. The expanded graphite of any one of the preceding claims, wherein the ratio of the intensity of the Raman Spectroscopy peak positions at the D band peak to the G band peak is 0 to about 0.1 (e.g., about 0.01 to about 0.08, such as about 0.02 to about 0.06 or about 0.04).

8. A process for manufacturing expanded graphite, the process comprising:
a. introducing a first stock into a reactor, the first stock comprising graphite (e.g., and an additive, such as a surfactant, stabilizing, and/or dispersing agent) and the reactor configured to produce a toroidal non-vortex (e.g., laminar or Couette) flow; and
b. collecting expanded graphite.

9. The process of claim 8, wherein the reactor is a batch reactor.

10. The process of claim 8, wherein the reactor is a continuous flow reactor.

11. The process of any one of the preceding claims, wherein the first stock is aqueous.

12. The process of any one of the preceding claims, wherein the flow is configured to apply shear forces to the first stock.

13. The process of any one of the preceding claims, wherein the flow is configured to apply a shear rate of at least 1,000 s⁻¹ to the first stock (e.g., at least 5,000 s⁻¹, at least 10,000 s⁻¹).

14. The process of any one of the preceding claims, wherein a time between introducing the first stock to the reactor and collecting the expanded graphite is less than 6 hours (e.g., about 3 hours or less, about 2 hours or less, about 1-hour or less, or the like).

15. The process of any one of the preceding claims, wherein the expanded graphite produced is as described in any one of claims 1-7.

16. The process of any one of the preceding claims, wherein the graphite is natural or synthetic graphite.

17. The process of any one of the preceding claims, wherein the graphite comprises a plurality of graphene sheets.

18. The process of any one of the preceding claims, wherein each of the plurality of graphene sheets have a two dimensional structure, the two dimensional structure having an average lateral dimension of about 15 μm or more (e.g., about 15 μm to about 400 μm, about 20 μm or more, about 25 μm or more, or the like).

19. The process of any one of the preceding claims, wherein the graphite is pre-treated/washed with acid and/or other intercalating agents.

20. The process of any one of the preceding claims, wherein the graphite is present in the first stock in a concentration of about 5 vol. % to about 25 vol. %.

21. The process of any one of the preceding claims, wherein the dispersing agent is present in the first stock in a concentration of about 0.05 vol. % to about 5 vol. %.

22. The process of any one of the preceding claims, wherein the stabilizing agent is present in the first stock in a concentration of about 0.05 vol. % to about 5 vol. %.

23. The process of any one of the preceding claims, wherein the graphite is well dispersed in the first stock (e.g., by stirring for 30-60 minutes before being introduced to the reactor).

24. The process of any one of the preceding claims, wherein the reactor is a (e.g., batch or continuous) Taylor-Couette reactor.

25. The process of any one of the preceding claims, wherein the reactor comprises a reactor chamber into which the first stock is introduced; the reactor chamber being configured between an outer surface of a cylindrical body and the inner surface of a cylindrical bore, one or both of the cylindrical body and/or cylindrical bore rotating around an axis thereof

26. The process of claim 25, wherein the inner surface of the cylindrical bore rotates.

27. The process of claim 25, wherein the inner surface of the cylindrical bore rotates while the outer surface of the cylindrical body remains idle.

28. The process of claim 25, wherein the outer surface of the cylindrical body rotates while the inner surface of the cylindrical bore remains idle.

29. The process of claim 25, wherein the inner surface of the cylindrical bore rotates while the outer surface of the cylindrical body rotates in an opposite direction.

30. The process of any one of the preceding claims, wherein the cylindrical body forms an elliptical (or oval), or circular cylinder.

31. The process of any one of the preceding claims, wherein the cylindrical bore is a circular cylindrical bore.
